(19) United States
(12) Patent Application Publication
(10) Pub. No.: US 2005/0221662 A1
(43) Pub. Date: Oct. 6, 2005

(54) Adaptor with extension wire

(76) Inventor: Fu-Sheng Lai, Keelung City (TW)

Correspondence Address: Fu-Sheng LAI, P.O. Box No. 6-57, Junghe, Taipei, 235, TW

(21) Appl. No.: 10/945,958

(22) Filed: Sep. 22, 2004

(30) Foreign Application Priority Data
Mar. 30, 2004 (TW) 093108662

(51) Int. Cl. H01R 11/00

(52) U.S. Cl. 439/502

(57) ABSTRACT

The present invention relates to an adaptor with an extension wire including: an adaptor, wherein a plug formed on a side and an electric signal wire formed on another side, with a connector or a terminal formed on an open end; an extension wire, wherein a plug formed on an end, to be connected with a socket of an electric appliance, and a socket formed on the other end, to be connected to a multi-sockets power supply, thereby avoiding an adjacent socket being covered by the large adaptor and every socket thereof can be utilized.

### BACKGROUND OF THE INVENTION

(a) Field of the Invention

The present invention relates to an adaptor with an extension wire, and more particularly to the adaptor with the extension wire to plug in a multi-sockets power supply, thereby an adjacent socket will not be covered by the large adaptor and every socket thereof can be utilized.

(b) Description of the Prior Art

An adaptor can be a charger, a rectifier, a transformer, or an AC/DC converter, which is commonly a large block, minimum 3 cm in width, with heavy weight. Referring to FIGS. 7 and 8. The distance between two adjacent sockets B1 and B2 of a multi-sockets power supply, installed on the wall D, is 1.5 cm to 2 cm, which is less than minimum 3 cm requirement of an adaptor; therefore B2 can be covered when plugging in B1. Consequently, referring to FIG. 9, not every socket of a multi-sockets C1 can be utilized by adaptors A.

The heavy adaptor hanging on the socket may incur displacement between a plug A1 and socket B1 after long use, causing adverse effect in electric conductivity and also unbalanced contacting surfaces thereof, thereby rising temperature on socket-plug contacting surfaces, resulting in damages on the plug or socket.

The adaptor A contacting with the surface of the socket C1 will downgrade the heat transmission, thereby raising temperature on the plug-socket contacting surface or a nearby shell, resulting in deformation or electric conducting degradation.

### SUMMARY OF THE INVENTION

The present invention relates to an adaptor with an extension wire, wherein the extension wire connects the adaptor and a multi-sockets power supply. Thereby, the adaptor can be placed on the floor without connecting to the socket directly and every socket thereof can be utilized.

With the extension wire connecting the adaptor and the power supply socket, the adaptor will not cover on or contact with the socket, thereby avoiding a temperature rises on contacting surfaces, as in the conventional product.

With the extension wire connecting the adaptor and the power supply socket, the adaptor will not be hanged on the socket, as in the conventional product.

To enable a further understanding of the said objectives and the technological methods of the invention herein, the brief description of the drawings below is followed by the detailed description of the preferred embodiments.

### BRIEF DESCRIPTION OF THE DRAWING

FIG. 1 shows an exploded elevational view of the present invention.

FIG. 2 shows a perspective view of a sales package of the present invention.

FIG. 3 shows a perspective view of another sales package of the present invention.

FIG. 4 shows a perspective view of the present invention when connecting with extension wires.

FIG. 5 shows a top view of the present invention when connecting with extension wires.

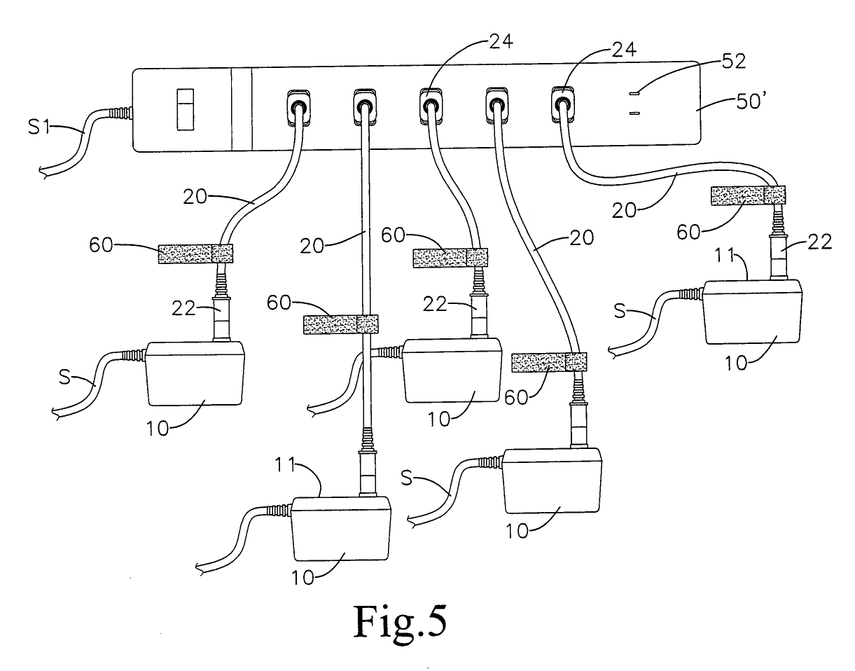

FIG. 6 shows a side view of the present invention when applying to sockets on the wall.

FIG. 7 shows an exploded elevational view of a conventional adaptor plugging in a multi-sockets power supply.

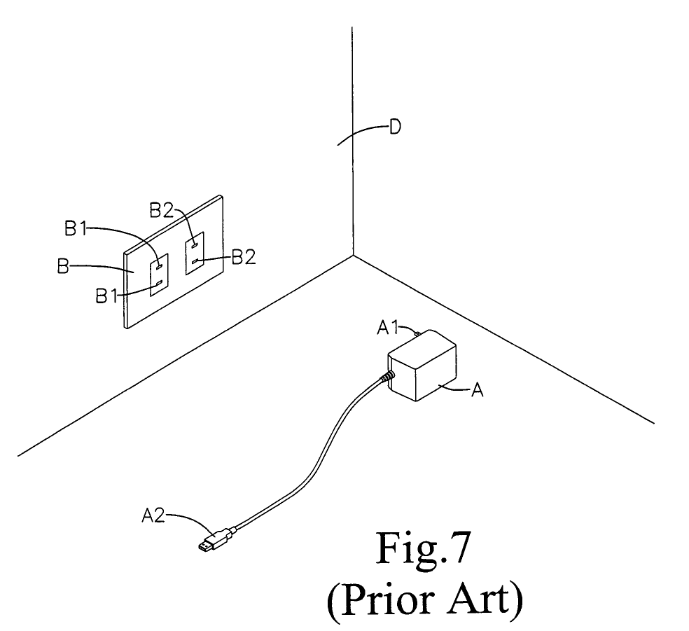

FIG. 8 shows a front view of a conventional adaptor plugging in the multi-sockets power supply.

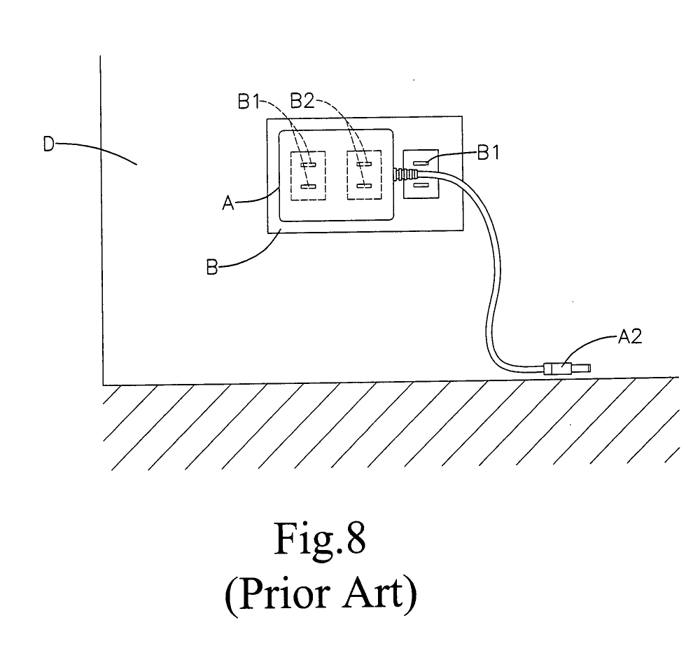

FIG. 9 shows a perspective view of a conventional adaptor plugging in a fixed extension wire of the multi-sockets power supply.

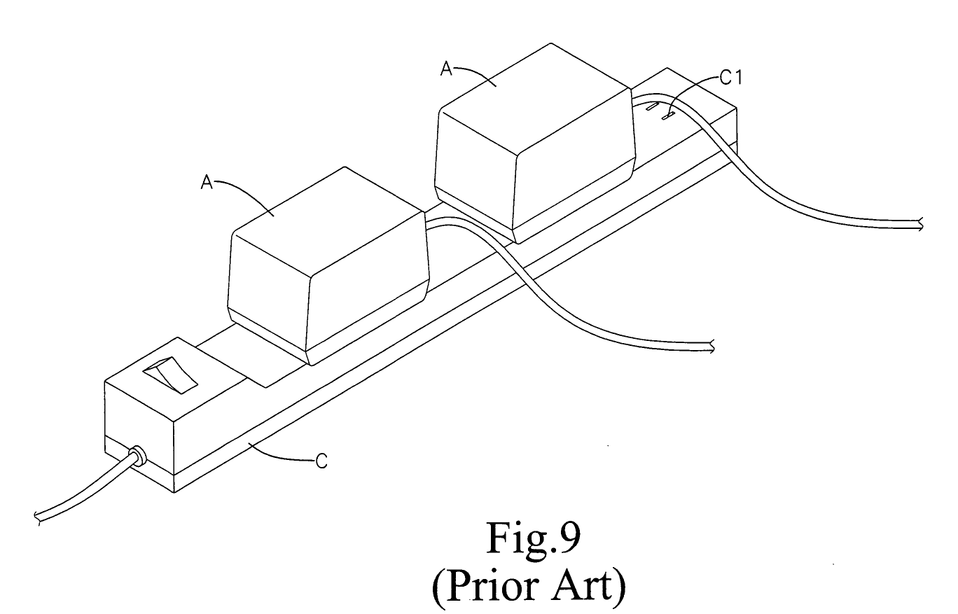

### DETAILED DESCRIPTION OF THE PREFERRED EMBODIMENTS

The present invention comprises
an adaptor 10, wherein a plug 12 formed on a side and an electric signal wire S formed on another side, with a connector 14 formed on an open end thereof;
an extension wire 20, with a plug 24 and a socket 22 formed on each end, wherein the socket 22 can be connected to a plug 12 on an electric appliance 10.

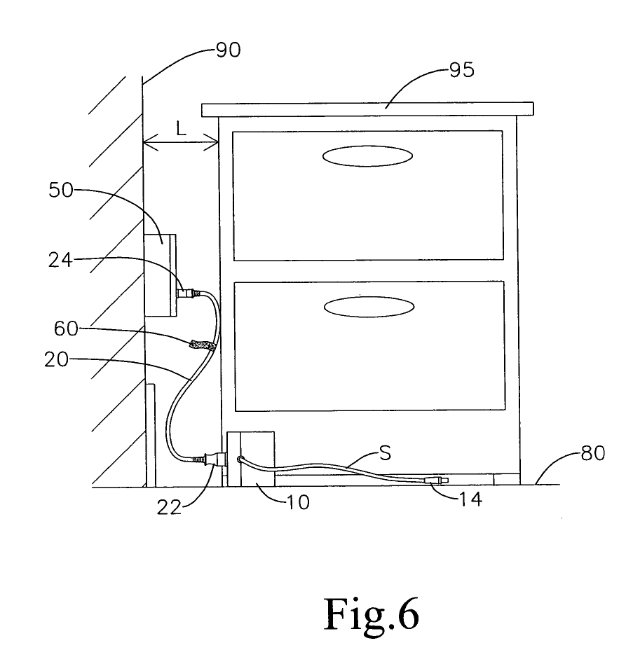

Referring to FIG. 6. The plug 24 of the extension wire 20 can be plugged in a multi-sockets power supply 50, with a distance between the adaptor 10 and the multi-sockets power supply 50, thereby avoiding the adaptor 10 covering on multi-sockets power supply 50.

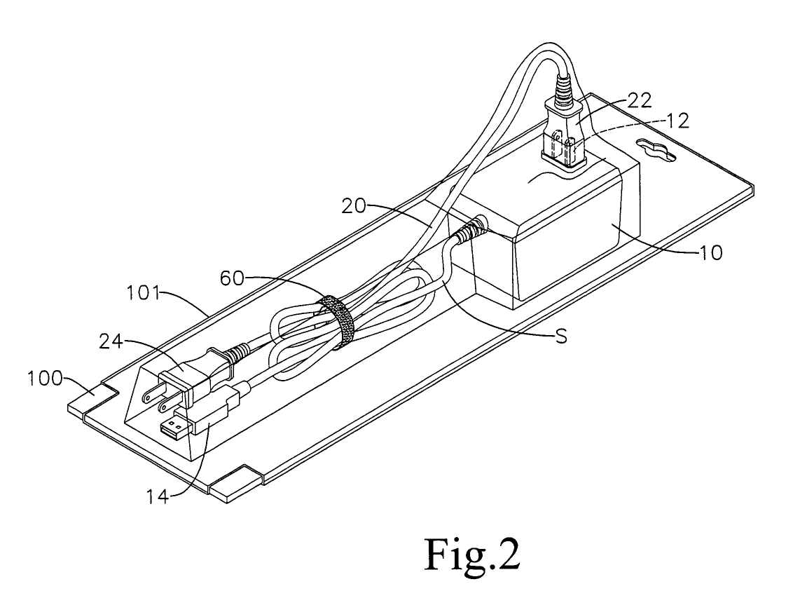

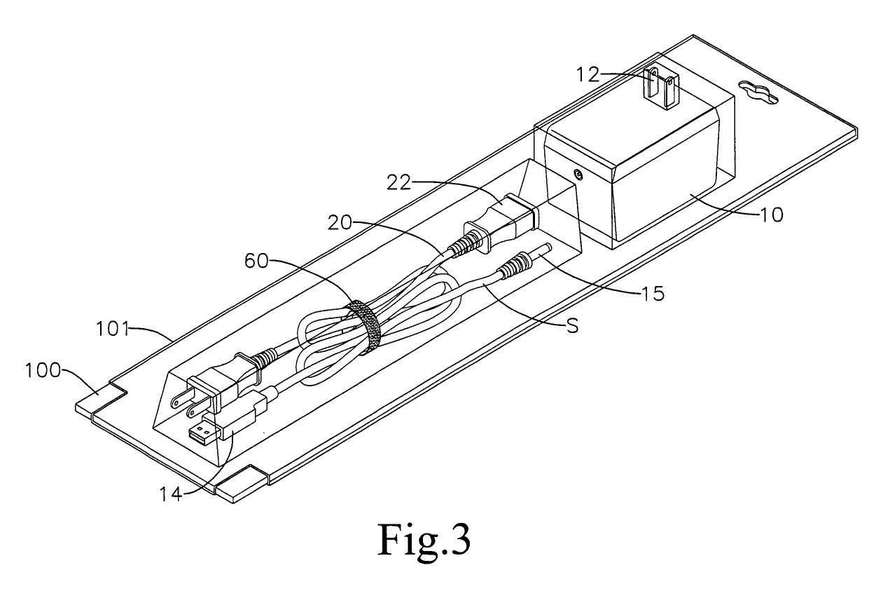

Referring to FIGS. 2 and 3. The extension wire 20 and the electric signal wire S of the adaptor 10 can be tied up with a fastening tape 60.

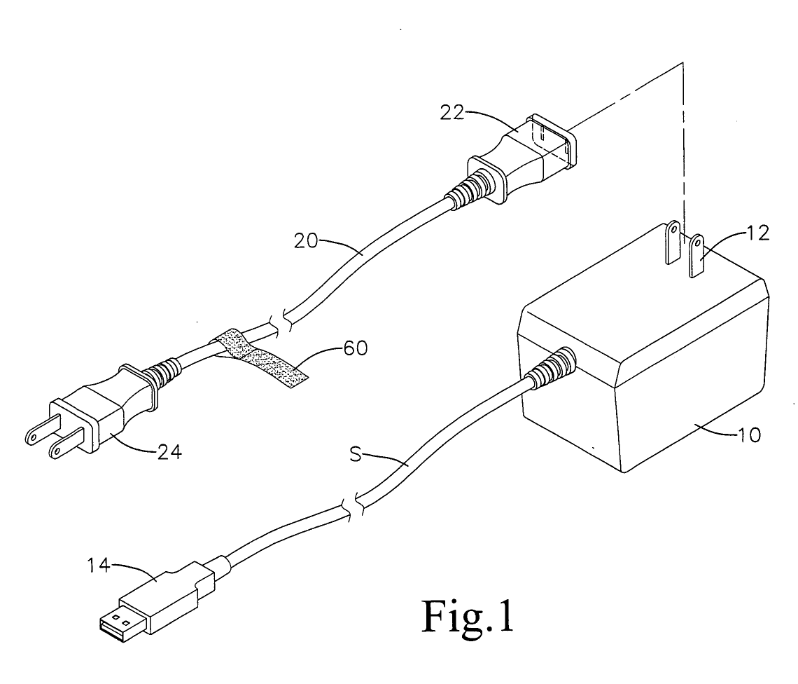

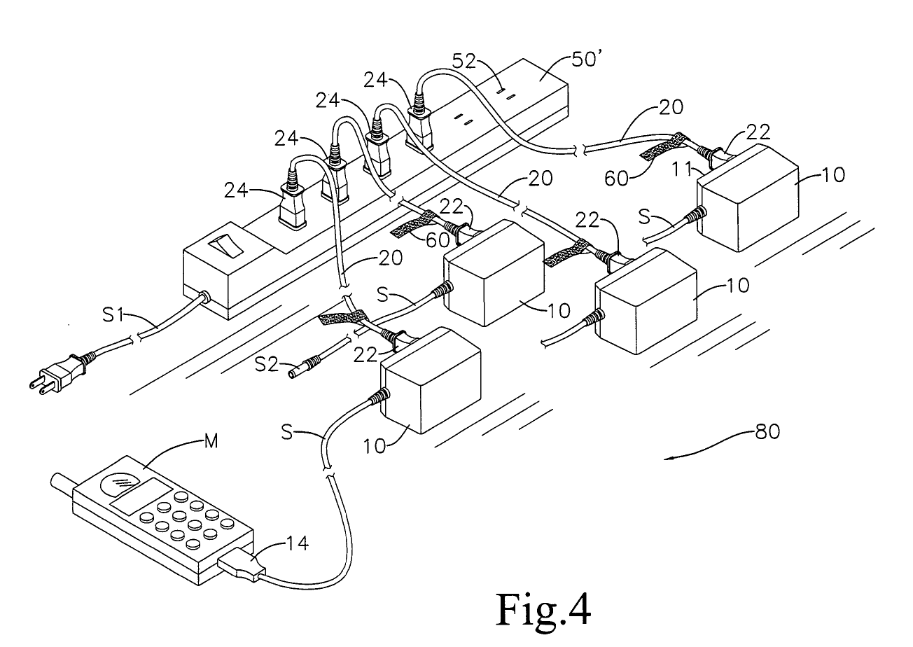

Referring to FIGS. 3 and 4. The open end of the electric signal wire S of the adaptor 10 can be a terminal S2 (or a plug);
Referring to FIGS. 1 and 4. The present invention is applied on the multi-sockets power supply 50 with a fixed extension wire S1. The connector 14 of the electric signal wire S can connect with an electric device, e.g. a mobile phone. The extension wire 20 connects with the plug 12 of the adaptor 10 by the socket 22 and with a socket 52 of the multi-sockets power supply 50 by the plug 24, thereby the adaptor 10 can be placed on the floor 80, keeping a distance with the multi-sockets power supply 50. Advantages can be summarized as follows,
(a) a bottom 11 of the adaptor 10 will not cover on the adjacent socket, thereby every plug 24 can find a socket 52;
(b) placing the adaptor 10 on the floor 80 prevents the heavy adaptor 10 contacting with or imposing upon the multi-sockets power supply 50;
(c) the bottom 11 of the adaptor 10 does not cover on the multi-sockets power supply 50, thereby keeping a normal heat dispersion on the socket-plug contacting surface.

Referring to FIG. 6. If the distance L between the multi-sockets power supply 50, installed on the wall 90, and a locker 95 on the right thereof is less than the thickness of the adaptor 10, then the extension wire 20 can be much useful in connecting the adaptor 10 with the multi-sockets power supply 50, by the socket 22 and the plug 24, respectively. The adaptor 10 can be placed on the floor 80.

Referring to FIG. 2. A sales package of packing a extension wire 20 and a adaptor 10 with a plastic sheet 101 and a bottom plate 100 can be easily made, with the plug 22 plugging in the socket 12 and with a fastening tape 60 tying the extension wire 20 and the electric signal wire S, thereby making the extension wire 20 an accessory of the adaptor 10.

Referring to FIG. 3. The electric signal wire S and the extension wire 20 can be tied separately when the electric signal wire S is to connect to the adaptor 10 through a cylinder terminal 15.

The adaptor 10 herein can be a rectifier, a transformer, or an AC/DC adaptor.

It is of course to be understood that the embodiment described herein is merely illustrative of the principles of the invention and that a wide variety of modifications thereto may be effected by persons skilled in the art without departing from the spirit and scope of the invention as set forth in the following claims.

1. An adaptor with an extension wire comprising:
an adaptor, wherein a plug formed on a side and an electric signal wire formed on another side, with a connector or a terminal formed on an open end;
an extension wire, wherein a plug formed on an end, to be connected with a socket of an electric appliance, and a socket formed on the other end, to be connected to a multi-sockets power supply.

2. The adaptor with an extension wire according to claim 1, wherein connecting can be made through the plug of the extension wire to the multi-sockets power supply to avoid the adaptor covering on the multi-sockets power supply.

3. The adaptor with an extension wire according to claim 1, wherein the extension wire and the electric signal wire of the adaptor can be tied up with a fastening tape.

4. The adaptor with an extension wire according to claim 1, wherein the adaptor can be a rectifier.

5. The adaptor with an extension wire according to claim 1, wherein the adaptor can be a transformer.

6. The adaptor with an extension wire according to claim 1, wherein the adaptor can be an AC/DC adaptor.

7. The adaptor with an extension wire according to claim 1, wherein a cylinder terminal can be an open end of the electric signal wire of the adaptor.
